(19) United States
(12) Patent Application Publication
(10) Pub. No.: US 2020/0354262 A1
(43) Pub. Date: Nov. 12, 2020

(54) HIGH SILICATE GLASS ARTICLES POSSESSING THROUGH GLASS VIAS AND METHODS OF MAKING AND USING THEREOF

(71) Applicant: CORNING INCORPORATED, Corning, NY (US)

(72) Inventors: Xiaoju Guo, Painted Post, NY (US); Tian Huang, Painted Post, NY (US); Yuhui Jin, Painted Post, NY (US); Tammy Lynn Petriwsky, Elmira, NY (US); Liying Zhang, Painted Post, NY (US)

(21) Appl. No.: 16/863,208

(22) Filed: Apr. 30, 2020

Related U.S. Application Data
(60) Provisional application No. 62/846,102, filed on May 10, 2019.

(51) Int. Cl. C03C 3/093; C03C 3/085; C03C 23/00; C03C 15/00

(52) U.S. Cl. CPC C03C 3/093; C03C 15/00; C03C 23/0025; C03C 3/085

(57) ABSTRACT

Disclosed herein are glass compositions with high silica content that present several advantages over glasses and other materials currently used for redistribution layers for RF, interposers, and similar applications. The glasses disclosed herein are low cost, flat glasses that have high throughput for the laser damage and etching process used to create through glass vias (TGVs). TGVs generated using the silicate glasses and processes described herein have large waist diameters, which is a desirable feature with respect to producing glass articles such as interposers.

This application claims the benefit of priority to U.S. Provisional Application Ser. No. 62/846,102 filed on May 10, 2019, the content of which is relied upon and incorporated herein by reference in its entirety.

### BACKGROUND

Today there is intense interest in thin glass with precision-formed holes for electronics applications. The holes are filled with a conducting material and are used to conduct electrical signals from one part to another to provide precise connection of central processing units, memory chips, graphical processing units, or other electronic components. For such applications, substrates with metalized holes in them are typically called “interposers.” As compared to presently used interposer materials, such as fiber-reinforced polymer or silicon, glass has a number of advantageous properties. Glass can be formed thin and smooth in large sheets without the need for polishing, it has higher stiffness and greater dimensional stability than organic alternatives, it is a much better electrical insulator than silicon, it has better dimensional (thermal and rigidity) stability than organic options, and it can be tailored to different coefficients of thermal expansion to control stack warp in integrated circuits. Electrical loss with glass elements is low, since glass is an insulator, while resistivity is high.

While the diameters of the holes (also referred to, when the etching process is completed, as “through glass vias” or TGVs) at the surface of the glass are wide, the diameters at the center of the glass or narrowest part (the “waist”) are often much lower. Improved TGV metallization and, hence, improved electrical performance would result from TGVs with wider waist diameters. In particular, a wider waist diameter may help reduce the dissipation of electromagnetic energy as heat (e.g., dielectric loss, Joule heating); this can be achieved when the interposer material has a low loss angle or loss tangent.

What is needed are new glass compositions that allow high-throughput glass manufacturing and enable the making of through glass vias with high waist diameters. Ideally, the glass compositions would also have desirable electrical properties for use with stacked integrated circuits and other electronic technologies. The subject matter of the present disclosure addresses these needs.

### SUMMARY

Disclosed herein are glass compositions with high silica content that present several advantages over glasses and other materials currently used for redistribution layers for RF, interposers, and similar applications. The glasses disclosed herein are low cost, flat glasses that have high throughput for the laser damage and etching process used to create through glass vias (TGVs). TGVs generated using the silicate glasses and processes described herein have large waist diameters, which is a desirable feature with respect to producing glass articles such as interposers.

In a first aspect, a silicate glass article comprises one or more through glass vias. The through glass via has a first surface diameter (D_{S1}), a second surface diameter (D_{S2}), and a waist diameter (D_{w}). The ratio of D_{S1}/D_{w} is from 1:1 to 2:1 and the ratio of D_{S2}/D_{w} is from 1:1 to 2:1. The silicate glass article comprises greater than 75 mol % SiO₂ and less than 2 mol % P₂O₅.

In a second aspect, a silicate glass article comprises one or more through glass vias. The through glass via has a first surface diameter (D_{S1}), a second surface diameter (D_{S2}), and a waist diameter (D_{w}). The ratio of D_{S1}/D_{w} is from 1:1 to 2:1 and the ratio of D_{S2}/D_{w} is from 1:1 to 2:1. The silicate glass article comprises greater than 75 mol % SiO₂ and less than 12 mol % Al₂O₃.

In a third aspect, the silicate glass article of the first aspect or second aspect comprises greater than 75 mol % to 95 mol % SiO₂.

In a fourth aspect, the silicate glass article of the first aspect or second aspect comprises 80 mol % to 95 mol % SiO₂.

In a fifth aspect, the silicate glass article of the first aspect or second aspect comprises 0.5 mol % to 10 mol % Al₂O₃.

In a sixth, the silicate glass article of the first aspect or second aspect does not include P₂O₅.

In a seventh aspect, the silicate glass article of the first aspect or second aspect does not include an alkali metal oxide.

In an eighth aspect, the silicate glass article of the first aspect or second aspect comprises:

greater than 75 mol % to 95 mol % SiO₂,

1 mol % to 13 mol % of at least one alkali metal oxide,

1 mol % to 10 mol % of at least one alkaline earth metal oxide,

1 mol % to 10 mol % Al₂O₃,

0 mol % to 10 mol % B₂O₃,

0.01 mol % to 4 mol % ZnO, and

0 mol % to 0.5 mol % SnO₂.

In a ninth aspect, the silicate glass article of the first aspect or second aspect comprises:

greater than 75 mol % to 85 mol % SiO₂,

1 mol % to 10 mol % Al₂O₃,

8 mol % to 13 mol % Na₂O, K₂O, or a combination thereof,

2 mol % to 8 mol % MgO, and

0.01 mol % to 0.5 mol % SnO₂.

In a tenth aspect, the silicate glass article in any of the preceding aspects wherein the through glass via has first surface diameter and the second surface diameter of from 10 μm to 100 μm.

In an eleventh aspect, the silicate glass article in any of the preceding aspects has a waist diameter of from 5 μm to 90 μm.

In a twelfth aspect, the silicate glass article in any of the preceding aspects has a thickness of from 50 μm to 500 μm.

In a thirteenth aspect, a method for producing a through glass via in a silicate glass article comprises the steps of: (1) irradiating the silicate glass article with a laser beam to produce a damage track, wherein the silicate glass article comprises greater than 75 mol % SiO₂ and less than 2 mol % P₂O₅; and (2) etching the silicate glass article with an etching solution comprising an acid to produce the through glass via.

In a fourteenth aspect, a method for producing a through glass via in a silicate glass article comprises the steps of: (1) irradiating the silicate glass article with a laser beam to produce a damage track, wherein the silicate glass article comprises greater than 75 mol % SiO₂ and less than 12 mol % Al₂O₃; and (2) etching the silicate glass article with an etching solution comprising an acid to produce the through glass via.

In a fifteenth aspect, the laser beam of the method of the thirteenth aspect or fourteenth aspect is formed with a picosecond laser.

In a sixteenth aspect, the laser beam of the method of the thirteenth aspect or fourteenth aspect has a wavelength of greater than 500 nm.

In a seventeenth aspect, the laser beam of the method of the thirteenth aspect or fourteenth aspect has a wavelength greater than 535 nm.

In an eighteenth aspect, the laser beam of the method of the thirteenth aspect or fourteenth aspect has a wavelength greater than 500 nm to 1,100 nm and a power from 40 μJ to 120 μJ.

In a nineteenth aspect, the laser beam of the method of the thirteenth aspect or fourteenth aspect is a laser burst.

In a twentieth aspect, the etching solution of the method of the thirteenth aspect or fourteenth aspect comprises hydrofluoric acid and water.

In a twenty-first aspect, the hydrofluoric acid of the method of the twentieth aspect has a concentration of from 1 wt % to 50 wt %.

In a twenty-second aspect, the etching solution of the method of twentieth aspect comprises hydrofluoric acid in combination with hydrochloric acid, sulfuric acid, nitric acid, acetic acid, or any combination thereof.

In a twenty-third embodiment aspect, the silicate glass article of the method of the thirteenth aspect or fourteenth aspect is etched at a temperature of from 0° C. to 50° C.

In a twenty-fourth aspect, the laser beam of the method of the thirteenth aspect or fourteenth aspect is a Bessel beam or a Gauss-Bessel beam.

In a twenty-fifth aspect, the irradiating of the method of the twenty-fourth aspect includes forming a focal line with the Bessel beam or Gauss-Bessel beam in the silicate glass article.

In a twenty-sixth aspect, the etching of the method of the thirteenth aspect or fourteenth embodiment aspect produces an etched byproduct, wherein the etched byproduct has an etched byproduct solubility greater than or equal to 0.5 g/L in the etching solution.

In a twenty-seventh aspect, the method of the twenty-sixth aspect where the etching solution comprises water, HF at a concentration of 0.1 M to 3.0 M, and HNO₃ at a concentration of 0.1 M to 3.0 M.

In a twenty-eighth aspect, in the method of any one of the thirteenth through the twenty-seventh aspects, the etch rate of the damage track (E₁) is greater than the etch rate of the article not damaged by the laser (E₂).

In a twenty-ninth aspect, the ratio of E₁/E₂ from the method of the twenty-eighth aspect is from 1 to 50.

In a thirtieth aspect, in the method of the twenty-eighth aspect, the acid is hydrofluoric acid and the etch rate E₂ is from 0.25 μm/min to 0.9 μm/min.

In a thirty-first aspect, the method of any one of the thirteenth through thirtieth aspects produces a silicate glass article.

The advantages of the materials, methods, and devices described herein will be set forth in part in the description that follows, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below:

FIG. 1 shows a schematic of the process of making through glass vias using the laser damage and etch strategy.

FIGS. 2A-2D shows a comparison of waist diameter of EXG and IRIS etched at room temperature (20° C.) in 1.45 M HF and 0.8 M HNO₃ for 112 minutes.

FIGS. 3A-3D shows a comparison of waist diameter of EXG and IRIS etched at 12° C. in 3 M HF with vertical and horizontal agitation at a speed of 25 mm/s.

FIG. 4 provides the etch rates (E2) of EXG (circle) and IRIS (diamond) in 1.45 M hydrofluoric acid.

### DETAILED DESCRIPTION

Before the present materials, articles and/or methods are disclosed and described, it is to be understood that the aspects described below are not limited to specific compounds, synthetic methods, or uses, as such may, of course, vary. It is also to be understood that the terminology used herein is for the purpose of describing particular aspects only and is not intended to be limiting.

In the specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “an alkaline earth metal oxide” in a glass composition includes mixtures of two or more alkaline earth metal oxides and the like.

“Optional” or “optionally” means that the subsequently described event or circumstance can or cannot occur, and that the description includes instances where the event or circumstance occurs and instances where it does not. For example, the glass compositions described herein may optionally contain an alkaline earth metal oxide, where the alkaline earth metal oxide may or may not be present.

As used herein, the term “about” is used to provide flexibility to a numerical range endpoint by providing that a given numerical value may be “a little above” or “a little below” the endpoint without affecting the desired result. For purposes of the present disclosure, “about” refers to a range extending from 10% below the numerical value to 10% above the numerical value. For example, if the numerical value is 10, “about 10” means between 9 and 11 inclusive of the endpoints 9 and 11.

Throughout this specification, unless the context dictates otherwise, the word “comprise,” or variations such as “comprises” or “comprising,” will be understood to imply the inclusion of a stated element, integer, step, or group of elements, integers, or steps, but not the exclusion of any other element, integer, step, or group of elements, integers, or steps.

As used herein, “through glass vias” (TGVs) are microscopic holes through a glass article. In some aspects, TGVs are filled or metalized with a conductive material such as copper. TGV refers to a single through glass via.

A TGV has a surface opening and extends all the way through a glass article. “Surface diameter” as used herein refers to the diameter (usually measured in μm) of the TGV at both surfaces of the glass (the first surface and the second surface), which are referred to herein as the first surface diameter (D_{S1}) and the second surface diameter (D_{S2}). Some TGV have regions in the interior (not at the surface) where the diameter is less than both the first surface diameter and the second surface diameter. Such TGV are referred to as having a “waist,” which is the narrowest point of the TGV located in the interior of the glass between the first surface and the second surface. “Waist diameter” as used herein refers to the diameter (also typically in μm) of the TGV at the waist. Unless otherwise specified, the length of a TGV refers to a linear dimension of the TGV in the thickness direction of the glass article and the diameter of a TGV refers to a linear dimension of the TGV in a direction transverse to the thickness dimension of the glass article. The term “diameter” will be used in reference to a TGV even if the cross-sectional shape of the TGV deviates from purely circular. In such instances, diameter refers to the longest linear dimension of the cross-sectional shape of the TGV (e.g. the major axis if the TGV has an elliptical cross-sectional shape). As used herein, the thickness direction of a glass article is the smallest of the length, height, and width dimensions of the glass article. When the TGV is formed by a process that includes forming damage tracks with a laser (see below), the thickness direction of the glass article corresponds to the direction of propagation of the laser beam.

The term “R₂O” refers to alkali metal oxides individually or collectively and includes any, or any combination of two or more, of Li₂O, Na₂O, K₂O, Rb₂O, and Cs₂O.

The term “RO” refers to alkaline earth metal oxides individually or collectively and includes any, or any combination of two or more, of MgO, CaO, SrO, and BaO.

References in the specification and claims to atomic percentages of a particular element in a composition or article denote the molar relationship between the element or component and any other elements or components in the composition or article for which an atomic percentage is expressed. Thus, in a composition containing 2 atomic percent of component X and 5 atomic percent of component Y, X and Y are present at a molar ratio of 2:5, and are present in such a ratio regardless of whether additional components are used in the composition.

As used herein, a plurality of items, structural elements, compositional elements, and/or materials may be presented in a common list for convenience. However, these lists should be construed as though each member of the list is individually identified as a separate and unique member. Thus, no individual member of any such list should be construed as a de facto equivalent of any other member of the same list based solely on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an example, a numerical range of “about 1” to “about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, from about 1—about 3, from 1 to about 3, from about 1 to 3, etc., as well as 1, 2, 3, 4, and 5, individually. The same principle applies to ranges reciting only one numerical value as a minimum or maximum. The ranges should be interpreted as including endpoints (e.g., when a range of “from about 1 to 3” is recited, the range includes both of the endpoints 1 and 3 as well as the values in between). Furthermore, such an interpretation should apply regardless of the breadth or range of the characters being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference to each various individual combination and permutation of these compounds may not be explicitly disclosed, each is specifically contemplated and described herein. For example, if an alkali metal oxide additive is disclosed and discussed, and a number of different alkaline earth metal oxide additives are discussed, each and every combination of alkali metal oxide additive and alkaline earth metal oxide additive that is possible is specifically contemplated unless specifically indicated to the contrary. For example, if a class of alkali metal oxides A, B, and C are disclosed, as well as a class of alkaline earth metal oxide additives D, E, and F, and an example combination of A+D is disclosed, then even if each is not individually recited, each is individually and collectively contemplated. Thus, in this example, each of the combinations A+E, A+F, B+D, B+E, B+F, C+D, C+E, and C+F is specifically contemplated and should be considered from disclosure of A, B, ad C; D, E, and F; and the example combination A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of the disclosure including, but not limited to, steps in methods of making and using the disclosed compositions. Thus, if there are a variety of additional steps that can be performed with any specific embodiment or combination of embodiments of the disclosed methods, each such composition is specifically contemplated and should be considered disclosed.

### I. Silicate Glass Article

Disclosed herein are silicate glass articles that can be processed by a laser damage and etch process described herein in order to create glass articles with one, several, or a plurality of TGVs. The silicate glass articles are formulated such that the TGVs formed have a waist diameter that approaches each surface diameter of the glass. Not wishing to be bound by theory, by increasing the amount of SiO₂ in the glass article, the solubility of the byproducts formed during the etching process can be increased. This in turn reduces the probability that the byproduct will accumulate as insoluble solids in the TGV. Accumulation of byproducts in the TGV is undesirable because it results in decreased waist diameter. By designing the glass composition to produce byproducts during etching with increased solubility, less accumulation of insoluble solids occurs in the TGV and larger waist diameters result. This is discussed in greater detail below.

The glasses articles used herein contain high amounts of SiO₂. In some aspects, the glass composition includes SiO₂ in an amount greater than 75 mol %. In some aspects, the SiO₂ is present in the amount greater than 75, 80, 85, 90, or 95 mol %, where any value can be a lower and upper endpoint (e.g., greater than 75 mol % to 95 mol %, greater than 75 mol % to 85 mol %, greater than 80 to 90 mol %, greater than 80 mol % to 95 mol %).

In some aspects, the silicate glass article includes greater than 75 mol % SiO₂ and less than 2 mol % P₂O₅. In some aspects, P₂O₅ is present at about 0, 0.25, 0.5, 0.75, 1, 1.25, 1.5, 1.75, or 2 mol %, where any value can be a lower and upper endpoint (e.g., 0.25 to 1.5 mol %, 1 to 1.75 mol %). In some aspects, the glass article does not include P₂O₅.

In some aspects, the silicate glass article can include Al₂O₃. In some aspects, the silicate glass article includes greater than 75 mol % SiO₂ and less than 12 mol % Al₂O₃. In some aspects, Al₂O₃ is present at about 0, 0.5, 1, 2, 3, 4, 5, 6, 7, 8, 9, 10 11, or less than 12 mol %, where any value can be a lower and upper endpoint (e.g., 0.5 mol % to 10 mol %, 1 to 10 mol %, 4 to 8 mol %).

In some aspects, the silicate glass article can include B₂O₃. In some aspects, the silicate glass article includes from 0 to 15 mol % B₂O₃, or includes about 0, 1, 2, 3, 4, 5, 6, 7, 8, 9, 10, 11, 12, 13, 14, or 15 mol % B₂O₃, where any value can be a lower and upper endpoint (e.g., 5 to 15 mol %, 0 to 5 mol %, 0 to 10 mol %).

In some aspects, the silicate glass article includes ZnO. In some aspect, the silicate glass article includes from 0 to 10 mol % ZnO, or includes about 0, 0.01, 0.05, 1, 1.5, 2, 2.5, 3, 3.5, 4, 4.5, 5, 5.5, 6, 6.5, or 7 mol % ZnO, where any value can be a lower and upper endpoint (e.g., 0 to 5 mol %, 0.01 to 1.5%, 0.01 to 4 mol %).

In some aspects, the silicate glass article includes one or more alkaline earth metal oxides (RO), where the sum of RO (MgO, BaO, CaO, and SrO) is in an amount of 1 to 10 mol %. In some aspects, the alkaline earth metal oxide is present at about 1, 2, 3, 4, 5, 6, 7, 8, 9, or 10 mol %, where any value can be a lower and upper endpoint (e.g., 1 to 10 mol %, 1 to 9 mol %, 2 to 8 mol %). In some aspects, the glass article only includes MgO as the alkaline earth metal oxide. In some aspects, the MgO is present at about 1, 2, 3, 4, 5, 6, 7, 8, 9, or 10 mol %, where any value can be a lower and upper endpoint (e.g., 1 to 10 mol %, 1 to 9 mol %, 2 to 8 mol %).

In some aspects, the silicate glass article includes one or more alkali metal oxides (R₂O) such as Li₂O, Na₂O, K₂O, Rb₂O, Cs₂O, or any combination thereof. In some aspects, the alkali metal oxide is present at about 0, 1, 2, 3, 4, 5, 6, 7, 8, 9, 10, 11, 12, or 13 mol %, where any value can be a lower and upper endpoint (e.g., 1 to 13 mol %, 8 to 13 mol %). In some aspects, the glass article only includes Na₂O, K₂O, or a combination thereof present at about 0, 1, 2, 3, 4, 5, 6, 7, 8, 9, 10, 11, 12, or 13 mol %, where any value can be a lower and upper endpoint (e.g., 1 to 13 mol %, 8 to 13 mol %). In some aspects, the glass article does not include an alkali metal oxide.

In some aspects, the silicate glass article includes SnO₂. In some aspects, SnO₂ is present in the glass article at about 0, 0.01, 0.05, 0.1, 0.2, 0.3, 0.4, or 0.5 mol %, where any value can be a lower and upper endpoint (e.g., 0.01 to 0.2 mol %, 0 to 0.5 mol %, 0.01 to 0.5 mol %).

In some aspects, the silicate glass article includes:

greater than 75 mol % to 95 mol % SiO₂,

0 mol % to 13 mol % of at least one alkali metal oxide,

1 mol % to 10 mol % of at least one alkaline earth metal oxide,

1 mol % to 10 mol % Al₂O₃,

0 mol % to 10 mol % B₂O₃,

0 mol % to 0.5 mol % SnO₂ and,

0 mol % to less than 2 mol % P₂O₅.

In some aspects, the silicate glass article includes:

greater than 75 mol % to 95 mol % SiO₂,

0 mol % to 13 mol % of at least one alkali metal oxide,

1 mol % to 10 mol % of at least one alkaline earth metal oxide,

1 mol % to 10 mol % Al₂O₃,

0 mol % to 10 mol % B₂O₃,

0.01 mol % to 4 mol % ZnO, and

0 mol % to 0.5 mol % SnO₂.

In some aspects, the silicate glass article includes:

greater than 75 mol % to 85 mol % SiO₂,

1 mol % to 10 mol % Al₂O₃,

8 mol % to 13 mol % Na₂O, K₂O, or a combination thereof,

2 mol % to 8 mol % MgO,

0.01 mol % to 0.5 mol % SnO₂, and

0 mol % to less than 2 mol % P₂O₅.

In some aspects, the silicate glass article includes:

greater than 75 mol % to 85 mol % SiO₂,

1 mol % to 10 mol % Al₂O₃,

8 mol % to 13 mol % Na₂O, K₂O, or a combination thereof,

2 mol % to 8 mol % MgO, and

0.01 mol % to 0.5 mol % SnO₂.

In some aspects, the glass compositions described herein can be manufactured into glass sheets and/or other glass articles using a high-throughput process. In some aspects, the glass compositions can be processed by a fusion draw process, a float process, or a rolling process.

The “fusion draw” process is a method of forming high performance flat glass. In the fusion draw process, raw materials are introduced into a melting tank at a temperature greater than 1,000° C. The molten glass is thoroughly mixed and then released, with uniform flow, into midair, where it feeds into drawing equipment while lengthening and beginning to cool. In some aspects, glasses formed by this process do not require surface polishing. In some aspects, glasses formed by this process have uniform thickness and are able to withstand high amounts of heat. In some aspects, the glasses disclosed herein can be formed into sheets using the fusion draw process.

The “float” method of forming glass is an alternative method for forming flat glass. After raw materials are melted and mixed, the molten glass flows onto a bath of hot tin. Float formed glass likely requires surface polishing and/or other post-production processing. In some aspects, the glasses disclosed herein can be formed into sheets using the float method.

As used herein, the “rolling” process for forming glass is similar to a drawing process, but conducted horizontally on rollers. Glass sheets made using the rolling process require grinding and polishing. In some aspects, the glasses disclosed herein can be formed into sheets using the rolling process.

### Process for Producing Through Glass Vias

The process for producing through glass vias in a silicate glass article involves (1) irradiating the silicate glass article with a laser beam to produce a damage track and (2) etching the glass article with an acid to produce the through glass via. Each step is described in detail below.

a. Formation of Damage Track

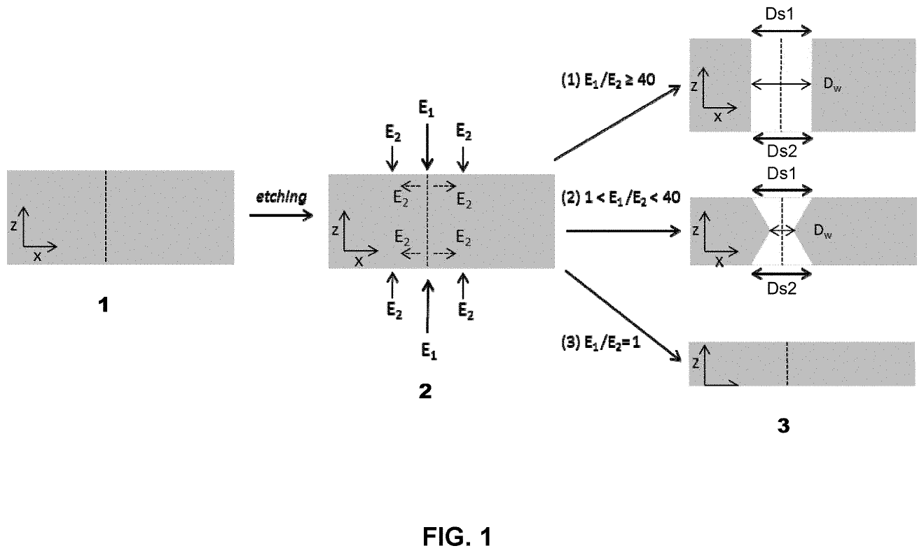

The first step of the process described herein involves producing one or more damage tracks in the silicate glass article. As used herein, a “damage track” is an area of glass that has been structurally modified by irradiation with a laser. The damage track is depicted in FIG. 1 as a dashed line through the laser damaged glass 1. In some aspects, a damage track has a lower refractive index than the surrounding undamaged glass. In some aspects, the lower refractive index may be due to volume expansion of the glass in the laser-irradiated area. In some aspects, glass in the damage track has a lower density than the surrounding undamaged glass. In some aspects, the damage track is a pit on the surface of the glass. In some aspects, the damage track is cylindrical or columnar in shape and extends partially or fully through the glass. In some aspects, the damage track includes bubbles, voids, or gaps.

The damage track can be produced using several different techniques. In some aspects, a pulsed laser beam is focused to a laser beam focal line oriented along the beam propagation direction and directed into the glass article, where the laser beam focal line generates an induced absorption within the glass. The induced absorption produces a damage track along the laser beam focal line within the glass. As used herein, “induced absorption” means multiphoton absorption or non-linear absorption of the laser beam. In some aspects, the glass article is transparent to the wavelength of the laser beam. As used herein, transparent means linear absorption of less than 10%/mm of thickness of the laser wavelength by the glass article. As used herein, a laser beam focal line corresponds to an approximately cylindrical region of illumination in the glass article with a central axis that extends in the direction of the damage track and a length greater than 0.1 mm. The intensity of laser light is approximately uniform throughout the laser beam focal line and is sufficiently high throughout the laser beam focal line to generate induced absorption.

In some aspects, by taking advantage of a specialized optical delivery system and a picosecond pulsed laser, damage tracks can be formed in the glass article with as little as a single laser pulse (or single burst of pulses) being required to form each damage track. In some aspects, this process permits damage track formation rates that are 100× or faster than what might be achieved with an ablative nanosecond laser process.

In some aspects, the laser beam focal line can be created by using a Bessel beam, a Gauss-Bessel beam, or other non-diffracting beam. As used herein, a non-diffracting laser beam is a laser beam having a Rayleigh range that is a factor of two or greater than the Rayleigh range of a Gaussian beam with the same pulse duration at the same wavelength. Further definition of Gauss and Gauss-Bessel beams may be found in: “High Aspect Ratio Nanochannel Machining Using Single Shot Femtosecond Bessel Beams”, M. K. Bhuyan, et al., Appl. Phys. Lett. 97, 081102 (2010); “M2 Factor of Bessel-Gauss Beams”, R. Borghi and M. Santasiero, Opt. Lett. 22, 262 (1997); “Application of Femtosecond Bessel-Gauss Beam in Microstructuring of Transparent Materials”, A. Marcinkevicius et al., in Optical Pulse and Beam Propagation III, Y. B. Band, ed., Proc. SPIE Vol. 4271, 150-158 (2001)

Further in some aspects, the laser beam focal line can be generated using an axicon or optic with a spherical aberration. In some aspects, the laser beam focal line can have a length in a range of between about 0.1 mm and about 10 mm, such as about 1 mm, about 2 mm, about 3 mm, about 4 mm, about 5 mm, about 6 mm, about 7 mm, about 8 mm, or about 9 mm, or a length in a range of between about 0.1 mm and about 1 mm, and an average diameter in a range of between about 0.1 μm and about 5 μm, or about 0.1, 0.25, 0.5, 1, 1.5, 2, 2.5, 3, 3.5, 4, 4.5, or 5 μm, where any value can be an upper and lower endpoint.

In some aspects, the pulse duration can be in a range of between greater than about 1 ps and less than about 100 ps, such as greater than about 5 ps and less than about 20 ps, or can be 1, 5, 10, 15, 20, 25, 30, 35, 40, 45, 50, 55, 60, 65, 70, 75, 80, 85, 90, 95, or 100 ps, where any value can be an upper and lower endpoint and the repetition rate can be in a range of between about 1 kHz and 4 MHz, such as in a range of between about 10 kHz and 650 kHz, or can be 1, 10, 50, 100, 150, 200, 250, 300, 350, 400, 450, 500, 550, 600, 650, 700, 750, 800, 850, 900, or 950 kHz or 1, 1.5, 2, 2.5, 3, 3.5, or 4 MHz, where any value can be an upper and lower endpoint.

In addition to a single pulse at the aforementioned repetition rates, in some aspects, the pulses can be produced in bursts of two pulses or more (such as 3 pulses, 4, pulses, 5 pulses or more) separated by a duration in a range of between about 1 ns and about 50 ns, or 1, 5, 10, 15, 20, 25, 30, 35, 40, 45, or 50 ns where any value can be an upper and lower endpoint such as, for example, 10 ns to 30 ns, such as about 20 ns±2 ns, at an energy of at least 40 μJ per burst, or 40 to 150 μJ, or 40 to 120 μJ, or about 40, 40, 50, 60, 80, 90, 100, 110, 120, 130, 140, or 150 μJ, where any value can be an upper and lower endpoint, and the burst repetition frequency can be in a range of between about 1 kHz and about 200 kHz, or between about 5 kHz and about 100 kHz, or can be 1, 5, 10, 50, 100, 150, or 200 kHz, where any value can be an upper and a lower endpoint. In some aspects, the energy of an individual pulse within the burst can be less, and the exact individual laser pulse energy will depend on the number of pulses within the burst and the rate of decay (e.g. exponential decay rate) of the laser pulses with time. For example, for a constant energy/burst, if a burst contains 10 individual laser pulses, then each individual laser pulse will contain less energy than if the same burst had only 2 individual laser pulses.

In some aspects, the damage track is formed in the glass when a single burst of pulses strikes substantially the same location on the glass article. That is, multiple laser pulses within a single burst correspond to a single damage track in the glass. In some aspects, since the glass is translated (for example by a constantly moving stage) or the beam is moved relative to the glass, the individual pulses within the burst cannot be at exactly the same spatial location on the glass. However, the pulses are well within 1 μm of one another so that they strike the glass at essentially the same location. For example, the pulses may strike the glass at a spacing (sp) where 0<sp 500 nm from one another. For example, when a location on the glass is hit with a burst of 20 pulses the individual pulses within the burst strike the glass within 250 nm of each other. Thus, in some aspects, the spacing sp is in a range from about 1 nm to about 250 nm or from about 1 nm to about 100 nm, or is 1, 5, 10, 25, 50, 75, 100, 125, 150, 175, 200, 225, or about 250 nm, where any value can be an upper and a lower endpoint.

The damage tracks created by the laser generally take the form of structurally modified regions (possibly containing debris resulting from damage of the glass within the laser beam focal line) with interior dimensions (e.g. longest dimension (such as a diameter) in a direction transverse to the direction of laser beam propagation) in the range of about 0.1 μm to 2 μm, for example 0.1-1.5 μm, or about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2 μm, where any value can be an upper and a lower endpoint. In some aspects, the damage tracks formed by the laser are small (single μm or less) in dimension. In some aspects, the damage tracks are 0.2 μm to 0.7 μm in diameter, or are 0.3 to 0.6 μm in diameter. In some aspects, the damage tracks are 0.1, 0.2, 0.3, 0.4, 0.5, 0.6, 0.7, 0.8, 0.9, or 1 μm in diameter, where any value can be an upper or lower endpoint. In some aspects, the damage tracks are not continuous holes or channels. In some aspects, the diameter of the damage tracks can be 5 μm or less, 4 μm or less, 3 μm or less, 2 μm or less, or 1 μm or less, where diameter refers to a linear dimension in a direction transverse to the direction of laser beam propagation. In some aspects, the diameter of the damage tracks can be in a range from greater than 100 nm to less than 2 μm, or from greater than 100 nm to less than 0.5 μm, or can be 100, 200, 300, 400, 500, 600, 700, 800, or 900 nm, or are 1, 1.1, 1.2, 1.3, 1.4, 1.5, 1.6, 1.7, 1.8, 1.9, or 2 μm, where any value can be an upper and a lower endpoint. In some aspects, at this stage, these damage tracks are un-etched (i.e., they have not yet been widened by the etching).

In some aspects, the damage tracks can perforate the entire thickness of the glass article, and may or may not form a continuous opening or channel throughout the depth of the glass. In some aspects, the damage tracks do not extend through the entire thickness of the glass. In some aspects, there are often regions of glass debris that plug or occupy the damage tracks, but they are generally small in size, on the order of μm, for example.

In some aspects, the glass has a plurality of damage tracks, wherein each of the damage tracks has a diameter of less than 5 μm, or from 1 to 5 μm, or from 2 to 3 μm, or has a diameter of 1, 2, 3, 4, or 5 μm, where any value can be an upper or a lower endpoint, a spacing between adjacent damage tracks of at least 20 μm, or of 20, 25, 30, 35, or 40 μm, where any value can be an upper and a lower endpoint, or a spacing of 20-25 μm, 25-35 μm, or 35 to 40 μm, and an aspect ratio of 20:1 or greater, or an aspect ratio of 25:1, or 30:1, or 35:1, or 40:1, where any value can be an upper and lower endpoint (e.g., from 25:1 to 40:1, or from 20:1 to 30:1). The diameter of the damage tracks can be less than 1 μm.

In some aspects, a glass article includes a stack of glass substrates with a plurality of damage tracks formed through the stack, wherein the damage tracks extend through each of the glass substrates, and wherein the damage tracks are between about 1 μm and about 100 μm in diameter and have a spacing of about 25 μm to about 1000 μm between adjacent damage tracks. In some aspects, the glass article can include at least two glass substrates separated by an air (or gas) gap larger than 10 μm. In some aspects, in this case the focal line length needs to be longer than the stack height. In some aspects, the stack of substrate may contain substrates of different glass compositions throughout the stack.

In some aspects, besides translating the glass article underneath the laser beam, it is possible to use other methods for rapidly moving the laser across the surface of the glass article to form a plurality of damage tracks such as, but not limited to, moving the optical head that delivers the laser beam, using galvanometers and f-theta lenses, acousto-optic deflectors, spatial light modulators, etc.

In some aspects, depending upon the desired pattern of damage tracks, the tracks can be created at a speed greater than about 50 damage tracks/s, greater than about 100 damage tracks/s, greater than about 500 damage tracks/s, greater than about 1,000 damage tracks/s, greater than about 2,000 damage tracks/s, greater than about 3,000 damage tracks/s, greater than about 4,000 damage tracks/s, greater than about 5,000 damage tracks/s, greater than about 6,000 damage tracks/s, greater than about 7,000 damage tracks/s, greater than about 8,000 damage tracks/s, greater than about 9,000 damage tracks/s, greater than about 10,000 damage tracks/s, greater than about 25,000 damage tracks/s, greater than about 50,000 damage tracks/s, greater than about 75,000 damage tracks/s, or greater than about 100,000 damage tracks/s, where any value can be an upper and a lower endpoint of a range (e.g., from 50 damage tracks/s to 3000 damage tracks/s, or from 1000 damage tracks/s to 7000 damage tracks/s).

In some aspects, the glass article is irradiated with a picosecond (ps) laser. In some aspects, the wavelength of irradiation is equal to or greater than 500 nm, or equal to or greater than 535 nm, or is from 500 nm to 1100 nm, or is 500 nm, 535 nm, 550 nm, 600 nm, 650 nm, 700 nm, 750 nm, 800 nm, 850 nm, 900 nm, 950 nm, 1000 nm, 1050 nm, or 1100 nm, where any value be a lower and upper endpoint of a range.

Exemplary settings and parameters for producing damage tracks in the glass compositions described herein are provided in the Examples.

b. Etching

After formation of the damage track(s) in the glass article, the glass article is etched with an etching solution composed of an acid to produce the through glass via(s) from the damage tracks. Acid etching allows for the formation of through glass vias with dimensions that are practical for metallization or other chemical coating. Here, all the damage tracks are enlarged in parallel to a target diameter in a parallel process, which is much faster than using a repeated application of laser pulses to enlarge the damage tracks to form vias having a large diameter. In some aspects, acid etching creates a stronger part compared to just using a laser to form TGVs, by avoiding formation of micro-cracks or other damage typically caused in the sidewalls of a TGV by a laser.

In some aspects, the etching solution is composed of one or more acids and water. In some aspects, the etching solution is composed of one or more acids and an organic solvent. Examples of organic solvents include, but are not limited to, alcohols such as ethanol.

The product of the reaction of the etching solution with the glass article is referred to herein as the “etched byproduct”. The etched byproduct can include soluble and/or insoluble compounds. As used herein, “etched byproduct solubility” refers to the saturation concentration of the etched byproduct in the etching solution. In some aspects, “the etched byproduct solubility” is quantified as the amount of etched byproduct dissolved in 1 L of etching solution when the etched byproduct is at the saturation concentration.

In some aspects, the glass article with damage tracks is etched with hydrofluoric acid (HF). In some aspects, the etching solution is water HF, where the HF has a concentration of from 1 wt % to 50 wt %, or has a concentration of about 1 wt %, 5 wt %, 10 wt %, 15 wt %, 20 wt %, 25 wt %, 30 wt %, 35 wt %, 40 wt %, 45 wt %, or 50 wt % in water, where any value can be a lower and upper endpoint of a range (e.g., 5 wt % to 20 wt %). In some aspects, the etching solution is HF in water having a concentration of 0.1 M, 0.5 M, 0.75 M, 1.0 M, 1.1 M, 1.2 M, 1.3 M, 1.4 M, 1.45 M, 1.5 M, 1.55 M, 1.6 M, 1.7 M, 1.8 M, 1.9 M, 2 M, 4 M, 6 M, 8 M, 10 M, 12 M, 14 M, 16 M, 18 M, 20 M, 22 M, 24 M, 26 M, 28 M, or 30 M where any value can be a lower and upper endpoint of a range (e.g., 1.3 M to 1.5) and “M” refers to concentration in units of molarity (moles/liter). In some aspect, the etching solution is HF in water having a concentration of 0.5 M to 2.0 M, 0.75 M to 1.8 M, 1.0 M to 1.6 M, or 1.3 M to 1.5 M.

In some aspects, the glass article is etched with HF in combination with one or more additional acids including, but not limited to, hydrochloric acid, sulfuric acid, nitric acid, acetic acid, or any combination or aqueous variations thereof. In some aspects, the etching solution is water and HF having a concentration of 0.1 M, 0.5 M, 0.75 M, 1.0 M, 1.1 M, 1.2 M, 1.3 M, 1.4 M, 1.45 M, 1.5 M, 1.55 M, 1.6 M, 1.7 M, 1.8 M, 1.9 M, 2 M, 4 M, 6 M, 8 M, 10 M, 12 M, 14 M, 16 M, 18 M, 20 M, 22 M, 24 M, 26 M, 28 M, or 30 M, where any value can be a lower and upper endpoint of a range (e.g., 1.3 M to 1.5 M, 1.45 M to 1.5 M) in combination with HNO₃ having a concentration of 0.2 M, 0.4 M, 0.6 M, 0.8 M, 1.0 M, 1.2 M, 1.4 M, 1.6 M, 1.8 M, 2.0 M, 3 M, 4 M, 5 M, or 6 M, where any value can be a lower and upper endpoint of a range (e.g., 0.6 M to 1.0 M, 0.4 to 0.8 M). In some aspects, the etching solution includes HF in water having a concentration of about 1.45 M and HNO₃ having a concentration of about 0.8 M.

In some aspects, the etched byproduct solubility may depend upon the temperature at which etching occurs. In some aspects, the glass article can be etched at a temperature of from 0° C. to 50° C., or can be etched at 0° C., 5° C., 10° C., 15° C., 20° C., 25° C., 30° C., 35° C., 40° C., 45° C., or 50° C., where any value can be a lower and upper endpoint of a range (e.g., 10° C. to 30° C., 15° C. to 25° C.). In some aspects, the glass article can be etched at 20° C.

In some aspects, the acid used is 10% HF/15% HNO₃ by volume. Further in some aspects, the glass article can be etched at about 25° C. for a time sufficient to remove about 100 μm of material from the thickness direction of the glass article. In some aspects, the glass article is etched from 30 minutes to two hours, or from 40 minutes to 1.5 hours, or from 50 minutes to one hour, or about 30 minutes, 40 minutes, 50 minutes, 1 hour, 1.25 hours, 1.5 hours, 1.75 hours, or 2 hours, where any value can be an upper and a lower endpoint of a range.

In some aspects, the glass article to be etched can be added to a tank of acid and physically agitated. In some aspects, the agitation can take the form of mechanical agitation, ultrasonic agitation, gas bubbling in the tank, or the like. In some aspects, the glass article can be immersed in an acid bath and ultrasonic agitation at a combination of 40 kHz and 80 kHz frequencies can be used to facilitate penetration of fluid (e.g. etchant) and fluid exchange in the damage tracks. In addition, manual agitation (e.g. mechanical agitation) of the glass article within the ultrasonic field can be performed to prevent standing wave patterns from the ultrasonic field from creating “hot spots” or cavitation-related damage on the glass article, and also to provide macroscopic fluid flow across the glass article.

The use of the glass compositions described herein and other process conditions makes it possible to minimize the accumulation of etched byproduct that collects in the through glass vias in the glass article. The accumulation of etched byproduct that collects in the through glass via reduces the waist diameter D_{w} relative to the surface diameter Dₛ of the through glass via, which is the smaller of D_{S1} or D_{S2} as shown in 3 at FIG. 1. As used herein, the waist diameter D_{w} refers to the narrowest portion of a via located between top diameter D_{S1} and bottom diameter D_{S2}. The accumulation of etched byproduct in the through glass via ultimately reduces the waist diameter D_{w}, which is undesirable.

Accumulation of etched byproduct occurs when the etched byproduct includes insoluble compounds (i.e., the portion of the etched byproduct that is insoluble in the etchant). The insoluble compounds become trapped in the TGV and act to reduce the waist diameter D_{w} of the TGV. The etched byproduct typically includes salts of metals present in the glass composition and the counterion of the etchant (acid). When the etchant is HF, for example, fluoride salts of metals present in the glass composition form as etched byproducts. Fluoride salts produced as etched byproducts of common glass compositions include alkali metal fluorides, alkaline earth metal fluorides, aluminum fluoride, metal fluorosilicates, metal fluoroaluminates, and metal fluoroborates.

In some aspects, etched byproduct is produced by the processes and methods described herein. In some aspects, etched byproduct is soluble or slightly soluble in the etching solution and the etched byproduct does not precipitate in the etching solution until a certain concentration of etched byproduct is produced by the processes and methods described herein. In some aspects, the etched byproduct has an etched byproduct solubility greater than or equal to 0.5 g/L in the etching solution. In some aspects, the etched byproduct has an etched byproduct solubility of 0.5, 1, 1.5, 2, 2.5, 3, 3.5, 4, 4.5, or 5 g/L of etching solution, where any value can be a lower and upper end-point of a range (e.g., 1 to 5 g/L, 2 to 4 g/L).

In some aspects, the etching solution used to determine the solubility of the etched byproduct includes water, HF, and HNO₃. In some aspects, the etching solution used to determine the etched byproduct solubility is composed of water, HF at concentration of 0.1 M to 3 M, 0.5 M to 1.8 M, 1 M to 1.6 M, or 1.3 M to 1.5 M and HNO₃ at a concentration of 0.1 M to 3 M, 0.2 M to 1.5 M, 0.5 M to 1 M, or 0.6 M to 0.9 M. In some aspects, the etching solution used to determine the etched byproduct solubility is composed of water, HF at concentration of 0.1 M to 2 M, 0.5 M to 1.8 M, 1 M to 1.6 M, or 1.3 M to 1.5 M and HNO₃ at a concentration of 0.1 M to 2 M, 0.2 M to 1.5 M, 0.5 M to 1 M, or 0.6 M to 0.9 M, and the etched byproduct is determined at 20° C. In some aspects, the etching solution used to determine the etched byproduct solubility is composed of water, HF at concentration of 1.45 M, and HNO₃ at a concentration of 0.8 M, and the etched byproduct is determined at 20° C. Unless otherwise specified, etched byproduct solubility is determined for a particular process using the lowest temperature at which etching occurs during the process.

In some aspects, the etch rate of the glass article (i.e, the time it takes for the etching solution to dissolve the glass in the damage track of the glass article (E₁) or the surface of the glass (i.e., the undamaged glass referred to herein as E₂) to produce the etched byproduct can affect the waist diameter of the through glass via. In some aspects, E1 (via etch rate) can be determined by the via open time. For example, the time (t1) when the via is formed through both sides of the glass (i.e., etched through) is recorded. The original thickness of the glass is recorded as (T0), and the etch rate is calculated using the formula E1=T0/(2×t1). In some aspects, the E2 (bulk etch rate) can be measured by monitoring the glass thickness change before and after etching. E2 is then calculated by the change in thickness of the glass divided by (2× etch time).

Referring to FIG. 1, the glass article includes a damage track (denoted by a dashed line and corresponding to the portion of the glass subjected to laser treatment) surrounded by undamaged glass (the portion of the glass not subjected to laser treatment). The damage track has an etch rate E₁ and the undamaged glass has an etch rate E₂ as shown in 2 in FIG. 1. Due to differences in the physical or chemical state of the damage track relative to the undamaged glass, the etch rates E₁ and E₂ differ (e.g., see 3 in FIG. 1). Typically, E₁>E₂ because the damage track includes a high concentration of structural defects that enhance the reactivity of the etching solution (e.g. acid solution). If etching byproduct accumulates in the damage track, the etch rate E₁ is decreased. By varying the etch rate E₁ relative to the etch rate E₂, the waist diameter D_{w} of the via can be modulated (i.e., increased or decreased).

In some aspects, the etch ratio E₁:E₂ can be used to modulate the waist diameter D_{w} of the TGV. In some aspects, the etch ratio E₁:E₂ is from 1 to 50, or is about 1, 2.5, 5, 10, 20, 30, 40, or 50, where any value can be a lower and upper endpoint of a range (e.g. 5 to 50, 10 to 40, or 15 to 30). In some aspects, the etch ratio E₁:E₂ is greater than 10, greater than 20, greater than 30, or greater than 40.

In some aspects, an etch rate E₂ of less than, for example, about 2 μm/min allows the etching solution (e.g. acid solution) to fully penetrate the damage tracks, especially when coupled with agitation to exchange fresh etching solution and remove dissolved material (e.g. soluble compounds of the etched byproduct) from the damage tracks, which are typically very narrow when initially formed by the laser. In some aspects, the damage tracks expand during etching at nearly the same rate throughout the thickness of the glass article (i.e. in the depth direction or throughout the length of the damage track). In some aspects, the etch rate E₂ can be a rate of less than about 10 μm/min, such as a rate of less than about 5 μm/min, or a rate of less than about 2 μm/min. In one aspect, the etch rate E₂ can be 0.1, 0.2, 0.25, 0.3, 0.4, 0.5, 0.6, 0.7, 0.8, 0.9, 1, 2, 3, 4, 5, 6, 7, 8, 9, or 10 μm/min, where any value can be an upper or a lower endpoint of a range (e.g., from 0.1 to 5 μm/min, from 0.25 to 0.9 μm/min, from 0.4 to 0.8 μm/min). In one aspect, the acid is hydrofluoric acid and the etch rate E₂ is from 0.25 μm/min to 0.9 μm/min.

In some aspects, the etch rates E₁ and E₂ can be controlled by adjusting an acid concentration in the etching solution. In other aspects, the orientation of the glass article in the etching tank, mechanical agitation, and/or the addition of surfactant to the etching solution can be modified to adjust the etching rates E₁ and E₂ and the attributes of the TGVs formed by enlarging the damage tracks. In some aspects, the etching solution is ultrasonically agitated and the glass article is oriented in the etching tank and positioned in the etching solution so that the top and bottom openings of the damage tracks receive substantially uniform exposure to the ultrasonic waves to promote uniform etching of the damage tracks. For example, if the ultrasonic transducers are arranged at the bottom of the etching tank, the glass article can be oriented in the etching tank so that the surfaces of the glass article with the damage tracks are perpendicular to the bottom of the etching tank rather than parallel to the bottom of the etching tank. In some aspects, the etching tank can be mechanically agitated in the x, y, and z directions to improve the uniformity of the etching of the damage tracks. In some aspects, the mechanical agitation in the x, y, and z directions can be continuous.

Using the glass compositions and processing conditions described herein, TGVs can be produced in glass articles where the waist diameter D_{w} approaches the diameter of the surface diameter Dₛ, where Dₛ corresponds to the lesser of D_{S1} and D_{S2} as depicted in FIG. 1. In some aspects, the ratio of D_{S1} and D_{S2} is 0.9:1, 0.95:1, 0.99:1, or 1:1. In some aspects, the ratio of the surface diameter (D_{S1} and D_{S2}) and the waist diameter (D_{w}) is from 1:1 to 2:1, or 1:1, 1.1:1, 1.2:1, 1.3:1, 1.4:1, 1.5:1, 1.6:1, 1.7:1, 1.8:1, 1.9:1, or 2:1, where any value can be a lower and upper endpoint of a range (e.g., 1.2:1 to 1.8:1).

In some aspects, the waist diameter D_{w} is about 50% or greater, about 55% or greater, about 60% or greater, about 65% or greater, about 70% or greater, about 75% or greater, about 80% or greater, about 85% or greater, about 90% or greater, about 95% or greater, or about 100% of the surface diameter Dₛ of the via, where Dₛ corresponds to the lesser of D_{S1} and D_{S2}. In some aspects, the waist diameter D_{w} of the hole is 50% to 100%, 50% to 95%, 50% to 90%, 50% to 85%, 50% to 80%, 50% to 75%, 50% to 70%, 55% to 100%, 55% to 95%, 55% to 90%, 55% to 85%, 55% to 80%, 55% to 75%, 55% to 70%, 60% to 100%, 60% to 95%, 60% to 60%, 60% to 85%, 60% to 80%, 60% to 75%, 60% to 70%, 65% to 100%, 65% to 95%, 65% to 90%, 65% to 85%, 65% to 80%, 65% to 75%, 65% to 70%, 70% to 100%, 70% to 95%, 70% to 90%, 70% to 85%, 70% to 80%, 70% to 75%, 75% to 100%, 75% to 95%, 75% to 90%, 75% to 85%, 75% to 80%, 80% to 100%, 80% to 95%, 80% to 90%, 80% to 85%, 85% to 100%, 85% to 95%, 85% to 90%, 90% to 100%, 90% to 95%, or 95% to 100% of the surface diameter Dₛ of the via, where any value can be a lower and upper endpoint of a range, and where Dₛ corresponds to the lesser of D_{S1} and D_{S2}.

In some aspects, a surfactant can be added to the etching solution to increase the wettability of the damage tracks. Without wishing to be bound by theory, the increased wettability provided by the surfactant lowers the diffusion time of the etching solution into a damage track and can allow for increasing the ratio of the waist diameter D_{w} of the TGV relative to the surface diameter Dₛ of the TGV. In some aspects, the surfactant can be any suitable surfactant that dissolves into the etching solution and that does not react with the acid(s) in the etching solution. In some embodiments, the surfactant is a fluorosurfactant such as Capstone® FS-50 or Capstone® FS-54. In some aspects, the concentration of the surfactant in terms of mL of surfactant/L of etching solution is about 1, about 1.1, about 1.2, about 1.3, about 1.4, about 1.5, about 1.6, about 1.7, about 1.8, about 1.9, about 2, or greater, or can be a range where any value is an upper or lower endpoint (e.g., about 1 to 2, about 1.2 to 1.8, about 1.3 to 1.5).

Each surface diameter Dₛ (i.e., D_{S1} and D_{S2}) of the through glass vias can vary depending upon processing conditions. In some aspects, each surface diameter Dₛ of the TGV is from 10 μm to 100 μm. In some aspects, each surface diameter Dₛ of the TGV is 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, or 100 μm, where any value can be a lower and upper endpoint (e.g., 20 μm to 80 μm). In some aspects, each surface diameter Dₛ of the TGV is from 10 μm to 100 μm. In some aspects, the waist diameter D_{w} of the TGV is 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, or 90 μm, where any value can be a lower and upper endpoint (e.g., 5 μm to 90 μm, 10 μm to 90 μm, or 20 μm to 80 μm, or 30 μm to 70 μm).

The glass article can have a plurality of through glass vias. In some aspects, the spacing (center to center distance) between adjacent vias is about 10 μm or greater, or about 20 μm or greater, or about 30 μm or greater, or about 40 μm or greater, or about 50 μm or greater, where any value can be an upper and lower endpoint (e.g., in the range from 10 μm to 100 μm, or in the range from 20 μm to 90 μm).

In some aspects, the glass article is a single glass sheet composed of a glass composition disclosed herein. In some aspects, the glass sheet has a thickness of from 50 μm to 500 μm, or has a thickness of about 50, 100, 150, 200, 250, 300, 350, 400, 450, or 500 μm, where any value can be a lower and upper endpoint (e.g., 100 μm to 300 μm). In other aspects, the glass article can be composed of two or more glass sheets, where one or more of the sheets are composed of a glass composition disclosed herein having a thickness disclosed herein.

In some aspects, the through glass vias have an aspect ratio (ratio of length to diameter) of about 1:1 or greater, about 2:1 or greater, about 3:1 or greater, about 4:1 or greater, about 5:1 or greater, about 6:1 or greater, about 7:1 or greater, about 8:1 or greater, about 9:1 or greater, about 10:1 or greater, about 11:1 or greater, about 12:1 or greater, about 13:1 or greater, about 14:1 or greater, about 15:1 or greater, about 16:1 or greater, about 17:1 or greater, about 18:1 or greater, about 19:1 or greater, about 20:1 or greater, about 25:1 or greater, about 30:1 or greater, or about 35:1 or greater. In some aspects, the aspect ratio of the through glass vias can be in a range from about 1:1 to 2:1, 5:1 to about 10:1, about 5:1 to 20:1, about 5:1 to 30:1, or about 10:1 to 20:1 about 10:1 to 30:1, where any value can be an upper and lower endpoint

The acid etching of the glass article to enlarge the damage tracks to form TGVs with diameters D_{w} and Dₛ can have a number of benefits: 1) acid etching changes the TGVs from a size (for example, about 1 μm for the initial damage track) that is too small to practically metalize and use for interposers to more convenient size (for example, 5 μm or higher); 2) etching can take what may start as a non-contiguous damage track through the glass and etch it to form a continuous though glass via; 3) etching is a highly parallel process where all of the damage tracks in a part are enlarged simultaneously to form TGVs, which is much faster than what would happen if a laser had to re-visit damage tracks multiple times to continually remove more material to enlarge the damage tracks; and 4) etching helps blunt any edges or small checks within the glass article, especially in the sidewalls of the TGVs that would be produced by repeated or prolonged laser application, increasing the overall strength and reliability of the material.

III. Applications of Glass Articles with TGVs

In some aspects, once formed, the glass article with TGVs may then be coated and/or filled with a conductive material, for example through metallization, in order to create an interposer made of the glass article. As used herein, “metallization” refers to a technique of coating a metal or other conductive material on the surface of an object or filling a TGV with metal or conductive material. Metallization and subsequent conductivity through the TGVs is improved when the ratio of surface diameter:waist diameter (Dₛ:D_{w}) approaches 1 and the TGVs are more cylindrical in shape, leading to a uniform cross-sectional area of the metal or conductive material in the TGV.

In some aspects, the metal or conductive materials, for example copper, aluminum, gold, silver, lead, tin, indium tin oxide, or a combination or alloy thereof. In some aspects, the process used to metalize the interior of the TGVs is, for example, electro-plating, electroless plating, physical vapor deposition, chemical vapor deposition, or evaporative coating. In some aspects, the TGVs may also be coated or lined with catalytic materials, such as platinum, palladium, titanium dioxide, or other materials that facilitate chemical reactions within the TGVs to promote metallization. In some aspects, the TGVs may be coated or lined with chemical functionalization, so as to change surface wetting properties or allow attachment of biomolecules and use for biochemical analysis. In some aspects, such chemical functionalization could be silanization of the glass surface of the TGVs, and/or additional attachment of specific proteins, antibodies, or other biologically specific molecules, designed to promote attachment of biomolecules to the surface of the TGVs for desired applications.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of the discovery disclosed herein. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Numerous variations and combinations of reaction conditions (e.g., component concentrations, desired solvents, solvent mixtures, temperatures, pressures, and other reaction ranges and conditions) can be used to optimize the product purity and yield obtained from the described process. Only reasonable and routine experimentation will be required to optimize such process conditions.

### Example 1: Laser Damage Test

Corning EAGLE XG® (EXG) and Corning IRIS glass (IRIS) (0.4 mm thickness each) were subjected to a laser treatment process to form damage tracks. The glass samples were laser processed to form damage tracks using a system equipped with a Coherent Hyper-Rapid-50 picosecond laser operating at wavelength of 532 nm. The beam delivery optics were configured to create a Gauss-Bessel laser beam focal line, with an optical intensity distribution along the beam propagation axis of 0.7 mm full-width half maximum, and a spot size of 1.2 μm in diameter, as measured by the diameter of the first nulls or intensity minimums in the cross-sectional profile of the Gauss-Bessel laser beam. Each damage track was formed by exposing the substrate to a single laser burst that contained 20 laser pulses (burst number=20) with a burst energy of 100 μJ. The spacing between each damage track was 150 μm.

### Example 2: Glass Etching

Following the laser treatment, the glass samples were etched as follows.

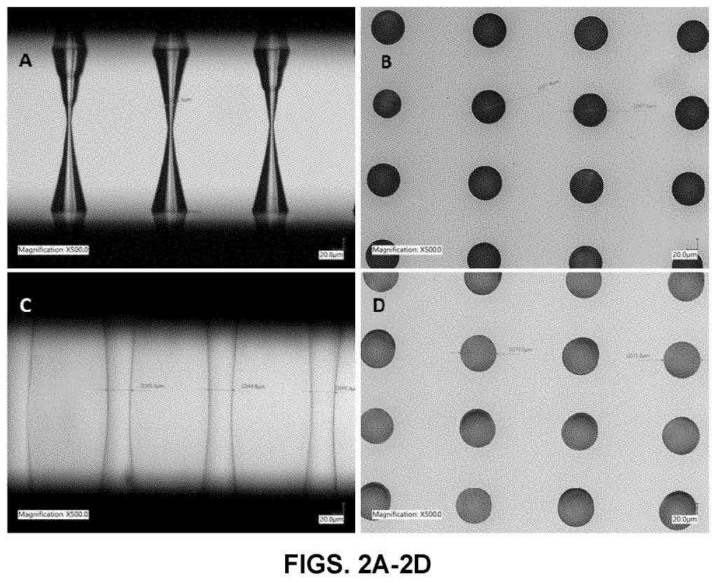

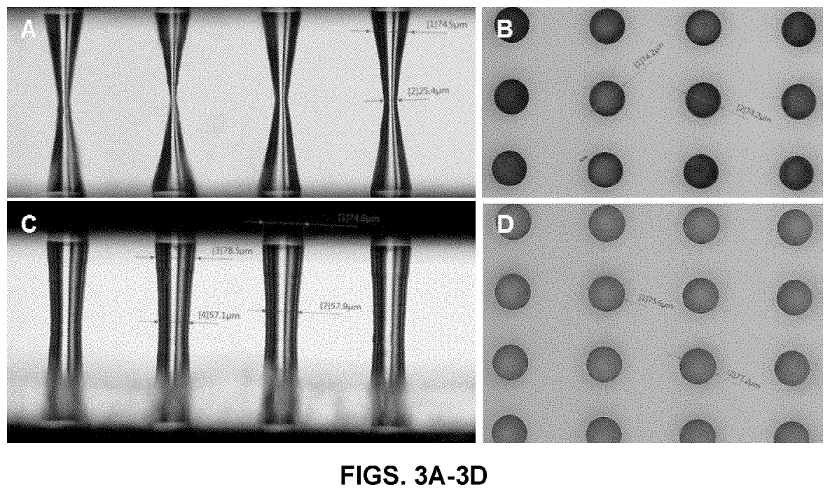

EXG was statically etched at room temperature (20° C.) in 1.45 M HF and 0.8 M HNO₃ for 112 minutes. The final top diameter was about 70 μm and the waist diameter was about 11.5 μm (FIGS. 2A-2B). In a second experiment, EXG was etched at 12° C. in 3 M HF with vertical and horizontal agitation at a speed of 25 mm/s. Final top diameter was about 75 μm and the waist diameter was about 25 μm (FIGS. 3A-3B).

IRIS was statically etched at room temperature (20° C.) in 1.45 M HF and 0.8 M HNO₃ for 240 minutes. The final top diameter was about 70 μm and the waist diameter was about 45 μm (FIGS. 2C-2D). In a second experiment, IRIS was etched at 12° C. in 3 M HF with vertical and horizontal agitation at a speed of 25 mm/s. The final top diameter was about 75 μm and the waist diameter was about 57 μm (FIGS. 3C-3D).

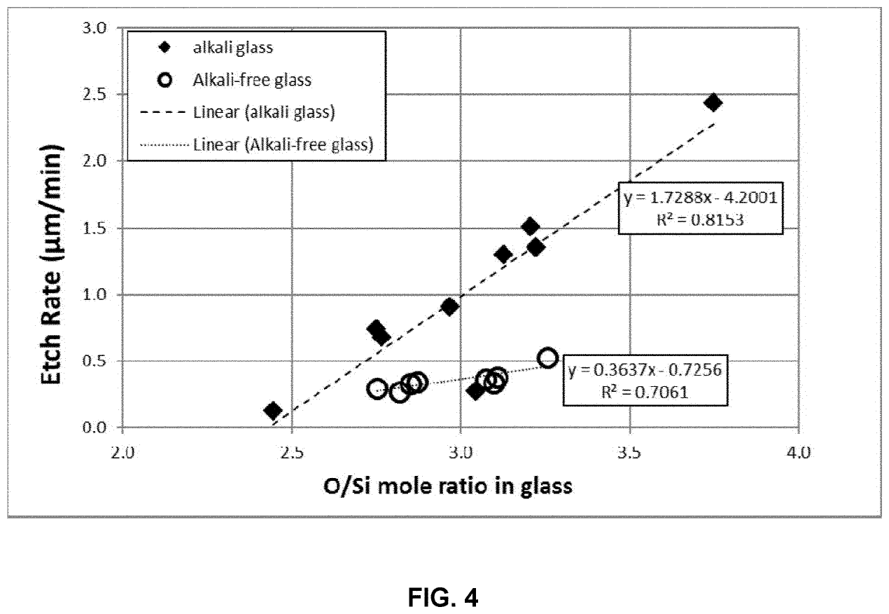

FIG. 4 provides the etch rates (E2) of EXG (circle) and IRIS (diamond) in 1.45 M hydrofluoric acid. For both glasses, the etch rates are well correlated with the O/Si mole ratio in the glasses, where the etch rate is slower with lower O/Si ratio in EXG when compared to the higher O/Si ratio in IRIS. This is consistent with the results above, where the waist diameter of IRIS glass is greater than the waist diameter of EXG when etched under the same conditions.

Throughout this publication, various publications are referenced. The disclosures of these publications in their entireties are hereby incorporated by reference into this application in order to more fully describe the methods, compositions, and compounds herein.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

What is claimed:

1. A silicate glass article comprising one or more through glass vias, wherein:
(a) the through glass via has a first surface diameter (D_{S1}), a second surface diameter (D_{S2}), and a waist diameter (D_{w}), wherein the ratio of D_{S1}/D_{w} is from 1:1 to 2:1 and the ratio of D_{S2}/D_{w} is from 1:1 to 2:1, and
(b) the silicate glass article comprises
a. greater than 75 mol % SiO₂ and
b. at least one of: less than 2 mol % P₂O₅ and less than 12 mol % Al₂O₃.

2. The silicate glass article of claim 1, wherein the silicate glass article comprises greater than 75 mol % to 95 mol % SiO₂.

3. The silicate glass article of claim 1, wherein the silicate glass article further comprises 0.5 mol % to 10 mol % Al₂O₃.

4. The silicate glass article of claim 1, wherein the silicate glass article does not include P₂O₅.

5. The silicate glass article of claim 1, wherein the silicate glass article does not include an alkali metal oxide.

6. The silicate glass article of claim 1, wherein the silicate glass article comprises:
greater than 75 mol % to 95 mol % SiO₂,
1 mol % to 13 mol % of at least one alkali metal oxide,
1 mol % to 10 mol % of at least one alkaline earth metal oxide,
1 mol % to 10 mol % Al₂O₃,
0 mol % to 10 mol % B₂O₃,
0.01 mol % to 4 mol % ZnO, and
0 mol % to 0.5 mol % SnO₂.

7. The silicate glass article of claim 1, wherein the silicate glass article comprises:
greater than 75 mol % to 85 mol % SiO₂,
1 mol % to 10 mol % Al₂O₃,
8 mol % to 13 mol % Na₂O, K₂O, or a combination thereof,
2 mol % to 8 mol % MgO, and
0.01 mol % to 0.5 mol % SnO₂.

8. The silicate glass article of claim 1, wherein the first surface diameter and the second surface diameter is from 10 μm to 100 μm.

9. The silicate glass article of claim 1, wherein the silicate glass article has a thickness from 50 μm to 500 μm.

10. A method for producing a through glass via in a silicate glass article, the method comprising:
(1) irradiating the silicate glass article with a laser beam to produce a damage track, wherein the silicate glass article comprises
a. greater than 75 mol % SiO₂ and
b. at least one of: less than 2 mol % P₂O₅ and less than 12 mol % Al₂O₃; and
(2) etching the silicate glass article with an etching solution comprising an acid to produce the through glass via.

11. The method of claim 10, wherein the laser beam is formed with a picosecond laser.

12. The method of claim 10, wherein the laser beam has a wavelength of greater than 500 nm.

13. The method of claim 10, wherein the laser beam has a wavelength greater than 500 nm to 1,100 nm and a power from 40 μJ to 120 μJ.

14. The method of claim 10, wherein the etching solution comprises hydrofluoric acid and water, wherein the hydrofluoric acid has a concentration of from 1 wt % to 50 wt %.

15. The method of claim 14, wherein the etching solution comprises hydrofluoric acid in combination with hydrochloric acid, sulfuric acid, nitric acid, acetic acid, or any combination thereof.

16. The method of claim 10, wherein the laser beam is a Bessel beam or a Gauss-Bessel beam.

17. The method of claim 10, wherein the etching produces an etched byproduct, wherein the etched byproduct has an etched byproduct solubility less than or equal to 5 g/L in the etching solution.

18. The method of claim 17, wherein the etching solution comprises water, HF at a concentration of 0.1 M to 3.0 M, and HNO₃ at a concentration of 0.1 M to 3.0 M.

19. The method of claim 10, wherein the etch rate of the damage track (E₁) is greater than the etch rate of the article not damaged by the laser (E₂), and the acid is hydrofluoric acid and the etch rate E₂ is from 0.25 μm/min to 0.9 μm/min.

20. The silicate glass article produced by the method of claim 10.
